(19) United States
(12) Patent Application Publication
(10) Pub. No.: US 2003/0193975 A1
(43) Pub. Date: Oct. 16, 2003

(54) Regenerative amplifier with frequency synthesizer

(76) Inventor: Yang Pang, San Jose, CA (US)

Correspondence Address: STALLMAN & POLLOCK LLP, Suite 290, 121 Spear Street, San Francisco, CA, 94105, US

(21) Appl. No.: 10/122,045

(22) Filed: Apr. 12, 2002

(51) Int. Cl. H01S 3/10

(52) U.S. Cl. 372/25

(57) ABSTRACT

A laser system includes a laser for generating seed pulses, and a regenerative amplifier for amplifying seed pulses generated by the seed pulse laser. The regenerative amplifier includes a gain-element pumped by optical pump pulses delivered by a pump laser, and an optical switch controlled synchronously with the delivery of pump-pulses such that amplified seed pulses can be delivered in a desired sequence different from but related to a constant rate at which optical pump pulses are delivered to the regenerative amplifier.

### TECHNICAL FIELD OF THE INVENTION

The present invention relates generally to amplification of ultrashort seed pulses in a regenerative amplifier. The invention relates in particular to a regenerative amplifier including a gain-element pumped by optical pump pulses, and a Pockels cell controlled such that output pulses can be delivered at a rate or in a sequence different from but related to the rate at which optical pump pulses are delivered to the regenerative amplifier.

### DISCUSSION OF BACKGROUND ART

Ultrashort pulses are generally considered to be pulses having a duration of about 10 picoseconds (ps) or less. One method of providing ultrashort pulses is to generate seed pulses using an ultrafast laser and amplify these seed pulses in a regenerative amplifier by a process generally referred to as chirped-pulse amplification (CPA). An ultrafast laser is generally regarded as a laser capable of delivering pulses at a rate from about 1 Hertz (Hz) up to 300 Kilohertz (KHz) or greater. In chirped pulse amplification, an ultrashort “seed” pulse is positively “chirped” (frequency modulated). The positive chirp stretches the duration of the pulse, thereby reducing the peak power in the pulse. The pulse is then amplified in a regenerative amplifier. Reducing the peak power in the seed-pulse enables the seed pulse to be amplified by several orders of magnitude, while keeping the peak power in the amplified pulse below levels that can cause damage or undesirable nonlinear optical effects in optical components of the amplifier. Following amplification, the amplified pulse can be negatively chirped to reduce the duration and increase the peak power of the pulse.

Gain-media used in the regenerative amplifiers include Ti:sapphire (Ti:Al₂O₃), alexandrite (Cr:Be₂O₃), coloquirites (for example Cr:LiSAF and Cr:LiCAF), neodymium-doped YAG (Nd:YAG), and ytterbium-doped YAG (Yb:YAG) in bulk (crystal) form. All of these gain-media exhibit thermal lensing effects when pumped at high average power levels, for example, at an average pump power of 20 Watts (W) or greater. Typically, in commercially available regenerative amplifiers, pumping of the gain-medium is effected by pulses delivered by a Q-switched, pulsed laser. Delivery of the pump pulses is synchronized with delivery of the seed pulses, and the rate of delivery of output pulses is determined by the rate of delivery of pump pulses. Accordingly, if the output pulse delivery rate is changed, the pump pulse delivery rate is also changed. Changing the delivery rate of the pump pulses changes the average power delivered to the gain medium. This changes the thermal load on the gain-medium and correspondingly the thermal lensing effect in the gain-medium. Changing thermal lensing effects can lead to inconsistency of beam quality in the output pulses. This can make it difficult to focus the pulses to a spot of consistent dimensions. There is a need for a regenerative amplifier in which output pulses can be provided at different frequencies while minimizing thermal lensing changes in the gain-medium.

### SUMMARY OF THE INVENTION

The present invention is directed to a method for operating an ultrafast laser system. The laser system includes a regenerative amplifier having a resonator including a gain-medium and an optical switch, a pulsed pump-laser for optically pumping the solid-state gain-medium, and a seed pulse laser for providing seed pulses to the regenerative amplifier. The optical switch is operable to admit a seed pulse to the resonator for amplification and to deliver the amplified seed pulse from the resonator. In one aspect of the inventive operating method, the seed pulse laser is operated to deliver a continuous train of seed pulses at a first pulse repetition frequency. The pump-laser is operated to deliver optical pump pulses to the gain-medium at a second pulse repetition frequency. The second pulse repetition frequency is a fraction 1/N of the first pulse repetition frequency, where N is an integer greater than 1. The optical switch is operated such that the resonator delivers amplified ones of the seed pulses as a sequence of temporally spaced apart bursts of 2 or more pulses, with the pulse repletion frequency in any of the bursts being 1/M of the second frequency where M is an integer greater than or equal to 1.

The first frequency is preferably about 100 MHz or less. The second frequency is preferably about 0.1 KHz or greater. In any sequence of bursts of pulses the temporal spacing between bursts may be the same or different, the pulse repletion rate of pulses in a burst may be the same of different from burst to burst, and the duration of the bursts may the same or different. Whatever the sequence of bursts, pump pulses are delivered to the gain-medium at a constant rate. This minimizes changes in thermal lensing in the gain medium.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 schematically illustrates a preferred embodiment of a laser system in accordance with the present invention including a regenerative amplifier optically pumped by a pump laser and including a Pockels cell, a seed pulse laser providing seed pulses and electronic pulses corresponding to the seed pulses, a frequency divider for dividing the frequency of the electronic pulses and delivering the frequency-divided electronic pulses as synchronizing pulses for triggering the pump laser, and a pulse selector arranged to also receive the synchronizing pulses and to control the Pockels cell to deliver amplified output pulses from the regenerative amplifier in a sequence thereof related to the frequency of the synchronizing pulses.

FIGS. 2A-D are graphs schematically illustrating one temporal relationship of the electronic pulses, synchronizing pulses, Pockels cell activation status and output pulses in the regenerative amplifier of FIG. 1, with output pulses delivered in a continuous train.

FIGS. 3A-D are graphs schematically illustrating another temporal relationship of the electronic pulses, synchronizing pulses, Pockels cell activation status and output pulses in the regenerative amplifier of FIG. 1, with output pulses delivered in a temporally spaced apart bursts or trains thereof having the same pulse repetition frequency in each burst.

FIGS. 4A-D are graphs schematically illustrating yet another temporal relationship of the electronic pulses, synchronizing pulses, Pockels cell activation status and output pulses in the regenerative amplifier of FIG. 1, with output pulses delivered in a temporally spaced apart bursts or trains thereof having a different pulse repetition frequency in each burst.

FIGS. 5A-D are graphs schematically illustrating still another temporal relationship of the electronic pulses, synchronizing pulses, Pockels cell activation status and output pulses in the regenerative amplifier of FIG. 1, with output pulses delivered in a temporally spaced apart bursts or trains thereof having the same pulse repetition frequency in each burst.

### DETAILED DESCRIPTION OF THE INVENTION

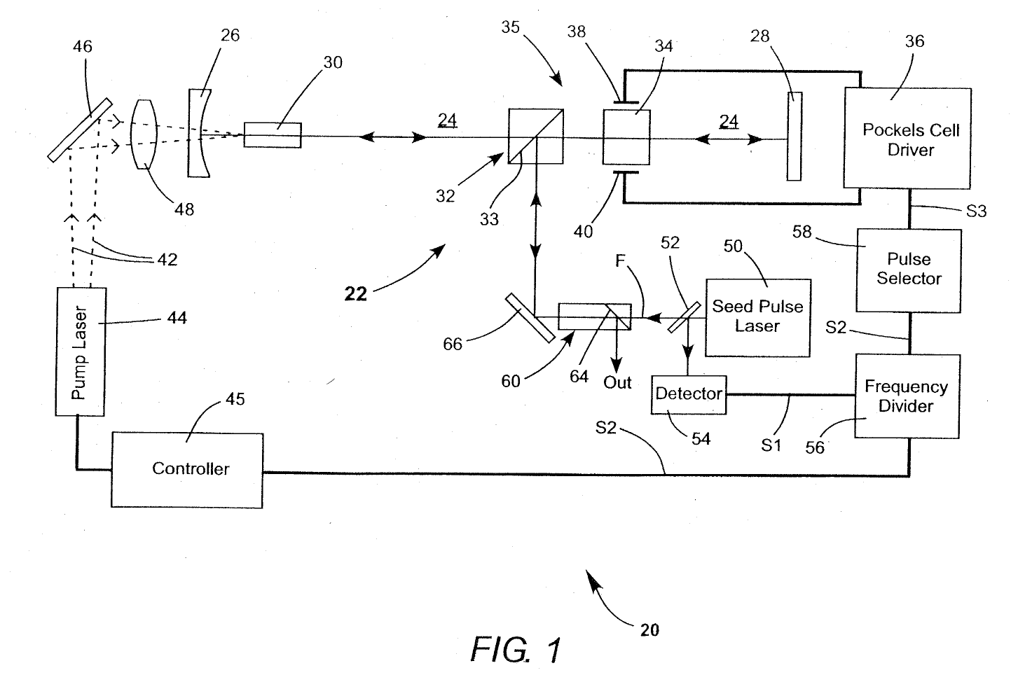

Referring now to the drawings, wherein like features are designated by like reference numerals, FIG. 1 schematically illustrates a laser system 20 in accordance with the present invention. It should be noted here that apparatus for temporally stretching seed pulses prior to amplification and temporally compressing the amplified seed pulses is not shown in FIG. 1 to simplify illustration. Such stretching and compressing is well known in the art and a description thereof is not necessary for understanding principles of the present invention. Laser system 20 includes a regenerative amplifier 22 having a resonator 24 terminated by mirrors 26 and 28. Resonator 24 includes a gain-medium or gain-element 30, a polarizing beamsplitter 32 and a Pockels cell 34. Gain-element 30 is preferably formed from a material selected from the group consisting of Ti:Al₂O₃, Cr:Be₂O₃, Cr:LiSAF, Cr:LiCAF, Nd:YAG, and Yb:YAG. This preference, however, should not be construed as limiting the present invention. Pockels cell 34 is operated by a driver or voltage source 36 via electrodes 38 and 40. Gain-element 30 is optically pumped by pump light 42 delivered by a pump laser 44. Operation of pump laser 44 is controlled by a controller 45. Pump light 42 from the pump laser is directed by a turning mirror 46 through a lens 48 that directs the pump light through mirror 26 and focuses the pump light into gain-element 30.

Seed pulses to be amplified are generated by a seed pulse laser. Seed pulse laser 50 is passively mode-locked and delivers seed pulses at a pulse repetition frequency (PRF) F of about 100 Megahertz (MHz) or less. Radiation in the seed pulses is plane polarized. A beamsplitter 52 directs a portion of each seed pulse to a detector 54, for example, a photodiode. Detector 54, accordingly, generates a signal S1 including a train of electronic pulses at the frequency F of the seed pulses. The signal is transmitted to a frequency divider circuit 56. Frequency divider circuit 56 selects every Nth pulse (where N is an integer greater than 1) from the seed-pulse-frequency signal S1 to provide a second signal S2 including a train of electronic pulses at a PRF of F/N. Signal S2 can be defined as a synchronizing signal, and pulses thereof are used to synchronize two operations in laser system 20.

A first of these operations is triggering pump laser 44 to deliver pump pulses to gain-element 30. Signal S2 is delivered to pump laser controller 45 which operates pump laser 44 to deliver a pump-pulse in response to every pulse in the signal, i.e., the PRF of pump pulses is F/N. Controller 45 is arranged to trigger the pump-pulses such that a seed pulse to be amplified arrives in gain-element 30 coincident with the leading edge of the pump pulse. The pump-pulse frequency F/N is the maximum frequency at which seed pulses can be amplified.

By way of example, a preferred pump-laser for pumping Ti:Al₂O₃ is a Q-switched, frequency-doubled, neodymium doped YAG (Nd:YAG) laser providing optical pump pulses having a wavelength of 530 (nanometers) nm. Such a laser can operate efficiently at frequencies up to about 25 Kilohertz (KHz). Accordingly, for such a pump-laser and a 100 MHz seed-pulse laser, N preferably has a value of about 400, providing a signal S2 having a PRF of about 25 KHz and, correspondingly providing optical pump pulses at this PRF.

The amplified pulses are useful in laser material processing applications such as laser drilling of injection nozzles and laser machining of microstructures in glass. Variable pulse repetition rate is a desirable feature in such laser material processing applications, as it affords precise control of a processed feature. It is also desirable for the laser to be able to stop and start delivery of pulses as the material processing operation demands. In a repeated process, programmed bursts of pulses assist in achieving consistent and reproducible results.

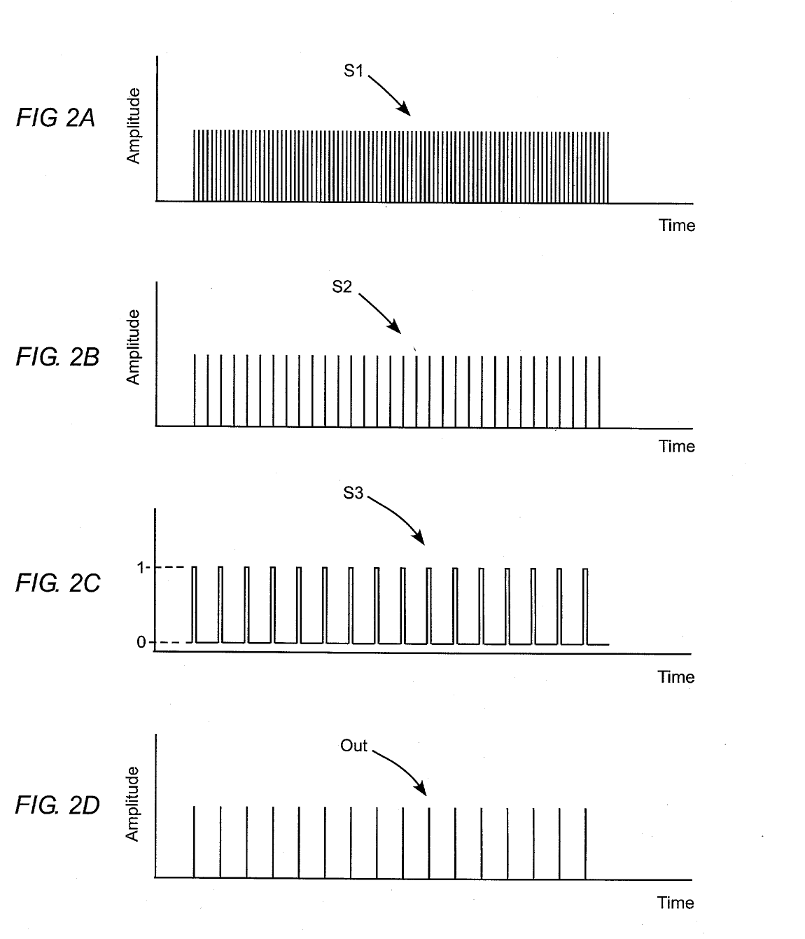

The second operation that is synchronized by signal S2 is the operation of Pockels cell 34 for selecting which ones of the pump pulses will amplify a corresponding seed pulse to produce a desired sequence of amplified seed pulses. A description of this operation is set forth below with continuing reference to FIG. 1 and additionally to FIGS. 2A-D, 3A-D and 4A-D.

The polarized seed pulses from seed pulse laser 50 are passed through an optical switch 60 including a polarizing beamsplitter surface 64 and a Faraday rotator (not shown). The Faraday rotator rotates the plane of polarized light in one direction of passage therethrough but does not rotate the polarization plane in the opposite direction of passage therethrough. The polarization plane of the seed pulses is arranged to allow the pulses to by transmitted by polarizing beamsplitter 64 after leaving the seed laser. On leaving optical switch 60, the polarization plane of the seed pulses has been rotated by 90 degrees by the Faraday rotator. The seed pulses are then directed by a turning mirror 66 into polarization beam splitter 32 of regenerative amplifier 22. Surface 33 of polarizing beamsplitter 32 reflects the pulses through Pockels cell 34. The Pockels cell, in combination with polarizing beamsplitter 32 functions as an optical switch designated in FIG. 1 by the general numeral 35.

Pockels cell 34 in what can be described as an unactivated mode, for example, with no potential applied by driver 36 across electrodes 38 and 40, allows the seed pulses to pass therethrough but rotates the plane of polarization of the pulses by 45 degrees. Accordingly, any pulses passing through Pockels cell 34 in the unactivated mode are reflected from mirror 28, and return through the Pockels cell, which again rotates the plane of polarization of the pulses by a further 45 degrees. Because of this, the plane of polarization of the pulses after two passages through the Pockels cell is rotated by 90 degrees. After the second pass through the Pockels cell, the pulses are transmitted through surface 33 of polarizing beamsplitter 34, pass through gain-element 30, and are reflected by mirror 26. The pulses then return through gain-element 30, through beamsplitter surface 33 and make another round trip through Pockels cell 34, as a result of which, the polarization plane of the pulses is rotated a further 90 degrees. In this polarization orientation, the pulses are then reflected out regenerative amplifier 22 by surface 33 of polarizing beamsplitter 32. The pulses are directed by turning mirror 66 into optical switch 60 and are reflected out of system 20 by beamsplitter surface 64 of the optical switch. With the Pockels cell in the above-described unactivated mode, optical switch 35 can be described as being in an open mode.

It should be noted here that at a seed-pulse-PRF (F) of 100 MHz, and a typical resonator length of less than one meter (1.0 m) for resonator 24, at the instant any seed pulse enters polarizing beamsplitter 32 for the first time, there will be no other seed pulse in resonator 24.

In order to amplify one of the seed pulses, that seed pulse is allowed to enter gain-element 30 as described above. Specifically, the Pockels cell initially is in the unactivated mode so that the pulse will pass into the gain medium. The pulse will then reflect off mirror 26 and pass through the gain medium a second time heading towards the Pockels cell. However, before reaching the Pockels cell 34, the Pockels cell is switched by a programmable, microprocessor-based pulse selector circuit 58 via driver 36 into an activated mode, for example, by driver 36 applying a potential across electrodes 38 and 40. In the preferred embodiment, the Pockels cell is activated at the instant the seed pulse arrives at gain-element 30 for the first time, i.e., coincident with the arrival of the leading edge of the pump pulse at the gain-medium.

In the activated mode, the Pockels cell rotates the plane of polarization of the seed pulse passing therethrough by 90 degrees, such that, in a forward and reverse pass through the Pockels cell, the orientation of polarization plane of the seed pulse is rotating by 180 degrees, allowing it pass through the beam splitter 32 on the next and successive passes. In this manner, the seed pulse is trapped in resonator 24 and is amplified by making a number of forward and reverse passages (round trips) through gain-element 30.

After a time determined to provide a predetermined number of round trips in the resonator for the seed pulse trapped therein, thereby allowing the pulse to be amplified by repeated passage through gain-element 30, Pockels cell 34 is deactivated. After a forward and reverse pass through the deactivated Pockels cell, the polarization plane of the amplified pulse is rotated by 90 degrees and the amplified pulse is directed out of system 20 by polarizing beamsplitter 32 via turning mirror 66 and polarizing beamsplitter 64, as described above for unamplified seed pulses.

With Pockels cell 34 in the activated mode, optical switch 35 can be defined as being in a closed mode. More specifically, while the switch is in the closed mode, any subsequent seed pulses entering the resonator via the beam splitter 32 will be rotated by 180 degrees after the double pass through the Pockels cell. This rotation will result in the pulse being immediately reflected out of the resonator when it reaches the beam splitter a second time. Meanwhile, the selected seed pulse will continue to circulate within the resonator, gaining energy.

The opening and closing of optical switch 35, i.e., the activating and deactivating of Pockels cell 34, is directed, as noted above, by pulse selector circuit 58 that is programmed with a desired sequence of output pulses. The sequence can be either a continuous sequence or a sequence of temporally spaced apart bursts. Pulse selector circuit 58 receives signal S2 from frequency divider 56. This is used to synchronize a digital signal S3 that is used to direct the activation and deactivation of Pockels cell 34. Accordingly, in any desired sequence of pulses directed by pulse selector 58, the pulse PRF can be no higher than the PRF of signal S2, as that signal also dictates the PRF of pump pulses delivered to gain-element 30. If pulses are delivered in temporally spaced-apart spaced bursts, the temporal separation between adjacent bursts will be an integer multiple of the temporal spacing between adjacent pulses in signal S2.

FIGS. 2A, 2B, 2C, and 2D, illustrate how one example of an output pulse sequence is generated in the inventive laser system. Here FIGS. 2A, 2B, and 2C schematically illustrate the form of signals S1, S2, and S3, respectively. In this illustration, and in similar illustrations discussed hereinbelow, the frequency of signal S1 is shown divided by only a factor of 3, for facility of illustration. In practice, as discussed above, division would be by a much greater integer. In the example of FIGS. 2A-D, pulse selector circuit 58 is programmed to provide amplified seed pulses using every second pump-pulse triggered by signal S2. FIG. 2C illustrates the form of the digital signal S3 provided by pulse selector circuit 58 for directing the opening and closing of optical switch 35. Here, a level of zero (0) represents the open mode of optical switch 35 (Pockels cell 34 unactivated) and a level of one (1) represents the closed mode of optical switch 35 (Pockels cell 34 unactivated). Seed pulses are amplified while the digital signal is held at the 1 level, with the amplified seed pulses (see FIG. 2D) delivered immediately after the signal of FIG. 2C falls from 1 to 0, i.e., at the falling edge of each pulse in signal S3.

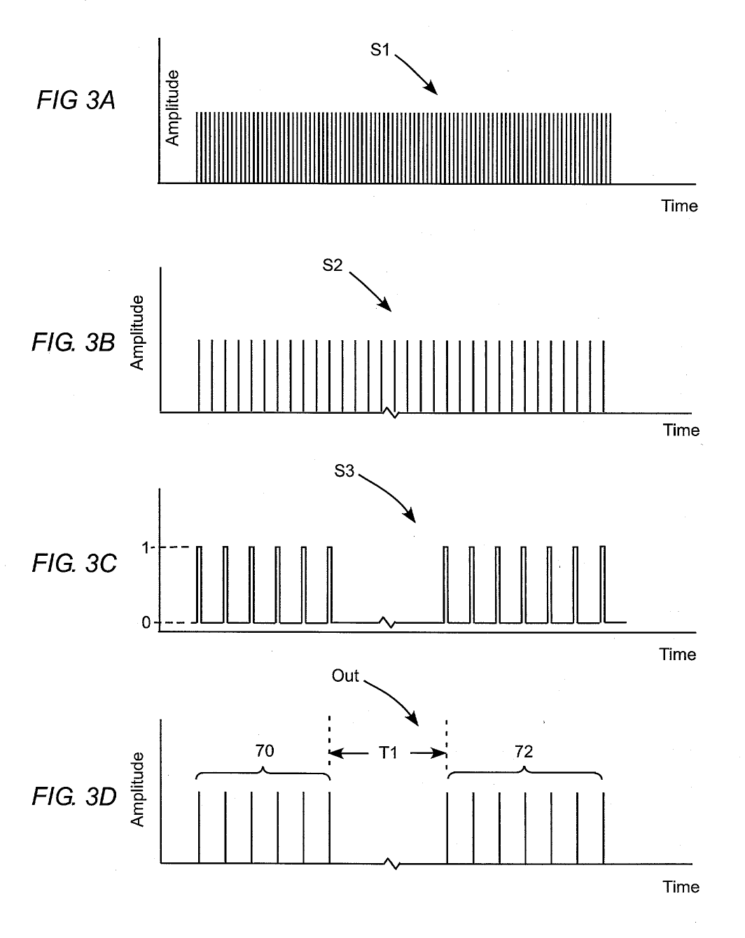

FIGS. 3A, 3B, 3C, and 3D, illustrate how another example of an output pulse sequence is generated in the inventive laser system. Here FIGS. 3A, 3B and 3C schematically illustrate the form of signals S1, S2 and S3, respectively, as discussed above with reference to FIGS. 2A and 2B. In this example, pulse selector circuit 58 is programmed to provide spaced-apart bursts 70 and 72 (see FIG. 3D) of amplified seed pulses using every second pump-pulse triggered by signal S2 during the bursts and leaving optical switch 35 in the open mode for the time T1 between the bursts. Time T1 may be as short as two pump pulse separation intervals or as long as one or more seconds. Time T1, however long or short, is an integer multiple of the temporal spacing between adjacent pulses of signal S2. FIG. 3C illustrates the form of the digital signal S3 provided by pulse selector circuit 58 for directing the opening and closing of optical switch 35 and FIG. 3D illustrates amplified seed pulses corresponding to the digital signal of FIG. 3C.

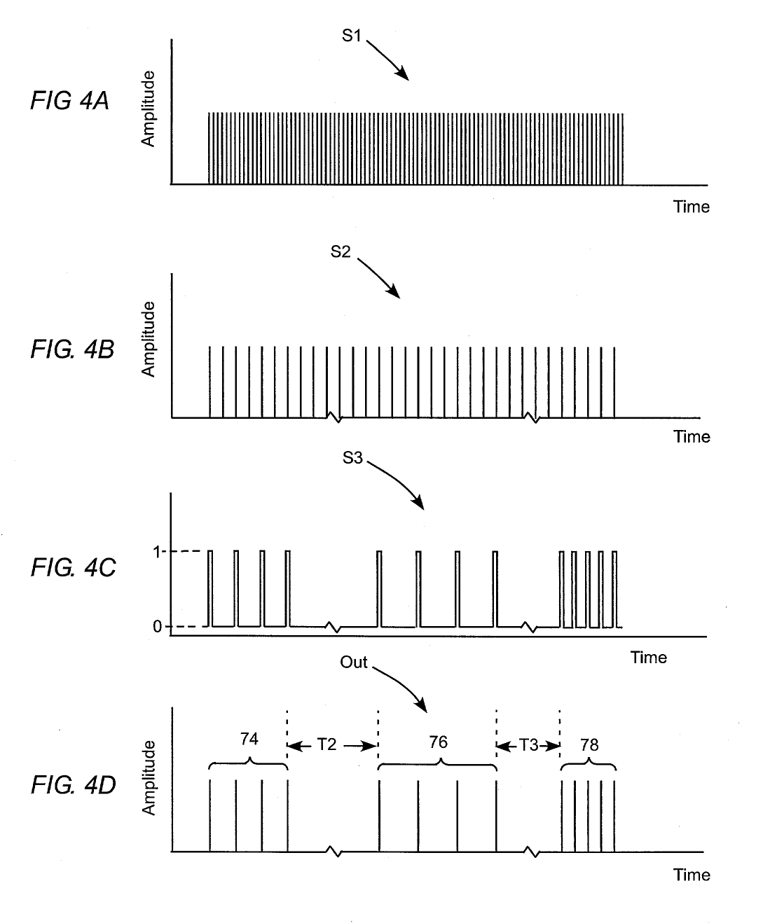

FIGS. 4A, 4B, 4C, and 4D, illustrate how yet another example of an output pulse sequence is generated in the inventive laser system. Here again, FIGS. 4A, 4B, and 4C schematically illustrate the form of signals S1 and S2, as discussed above with reference to FIGS. 2A and 2B. In this example, pulse selector circuit 58 is programmed to provide temporally spaced-apart bursts 74, 76 and 78 of amplified seed pulses (see FIG. 4D). Every second pump-pulse triggered by signal S2 is used during the generation of burst 74, every third pump-pulse triggered by signal S2 is used during the generation of burst 76, and each pump-pulse triggered by signal S2 is used during the generation of burst 78. The PRF in burst 78 is the maximum possible for the particular PRF of signal S2. Optical switch 35 in the open mode for the times T2 and T3 between bursts 74 and 76, and 76 and 78 respectively. FIG. 4C illustrates the form of the digital signal S3 provided by pulse selector circuit 58 for directing the opening and closing of optical switch 35 and FIG. 4D illustrates amplified seed pulses corresponding to the digital signal of FIG. 4C.

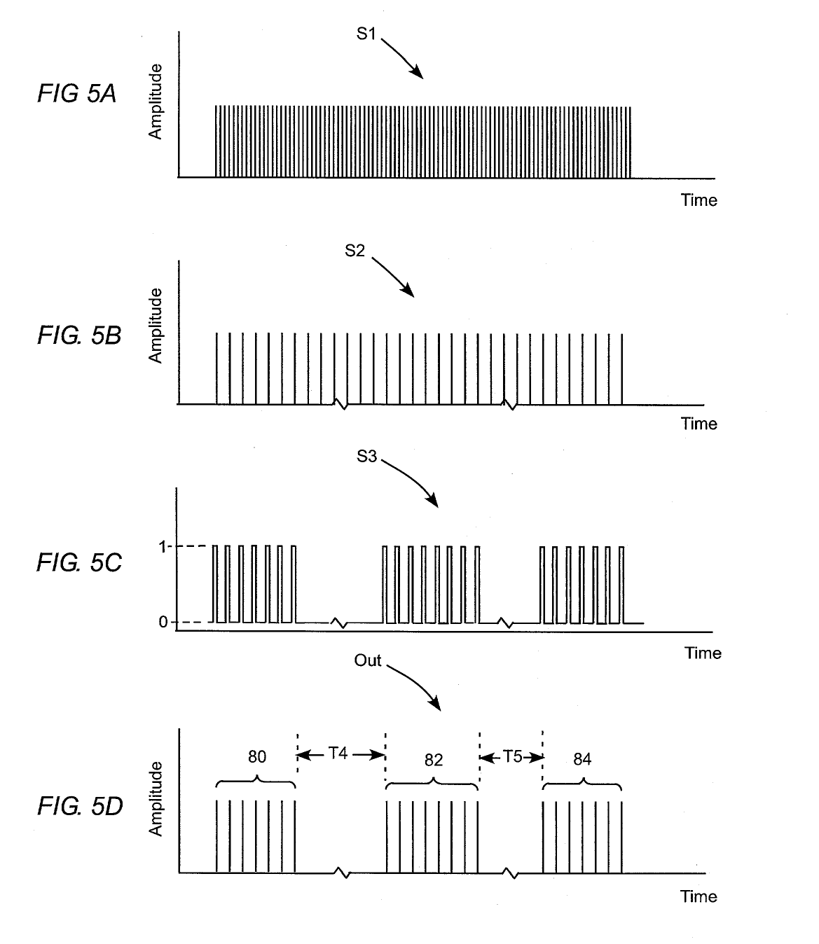

FIGS. 5A, 5B, 5C, and 5D, illustrate how yet another example of an output pulse sequence is generated in the inventive laser system. Here yet again, FIGS. 5A and 5B schematically illustrate the form of signals S1 and S2 respectively, as discussed above with reference to FIGS. 2A and 2B. In this example, pulse selector circuit 58 is programmed to provide temporally spaced-apart bursts 80, 82 and 84 of amplified seed pulses (see FIG. 5D). Every pump-pulse triggered by signal S2 is used during the generation of each of the bursts. The PRF in each of the bursts is the maximum possible for the particular PRF of signal S2. Optical switch 35 in the open mode for the times T4 and T5 between bursts 74 and 76, and 76 and 78 respectively. FIG. 4C illustrates the form of the digital signal provided by pulse selector circuit 58 for directing the opening and closing of optical switch 35, and FIG. 4D illustrates amplified seed pulses corresponding to the digital signal of FIG. 4C. It should be noted that times T4 and T5 of this example, and times T2 and T3 of the example of FIGS. 4A-D are similar in duration to time T1 in the example of FIGS. 3A-D, and are integer multiples of the temporal spacing of adjacent pulses in signal S2.

In summary the present invention as described above provides that a laser system including a regenerative amplifier can be operated to provide a sequence of optical pulses. The regenerative amplifier includes a gain medium that is optically pumped by pump pulses from a pump laser. The optical pulses may be delivered in a continuous sequence at a pulse repetition frequency less than the pulse repetition frequency at which the optical pump pulses are delivered to the gain medium. The optical pulses may also be delivered as sequence of bursts of pulses. The pulse repetition frequency in a burst may be the same as or some integer sub multiple of the pulse repetition frequency at which pump pulses are delivered to the gain medium. In any sequence of bursts of pulses, the temporal spacing between bursts may be the same or different, the pulse repetition rate of pulses in a burst may be the same or different from burst to burst, and the duration of the bursts may the same or different. Whatever the delivery sequence of amplified pulses, pump pulses are delivered to the gain-medium at a constant rate. This minimizes changes in thermal lensing in the gain-medium.

The present invention is described above in terms of a preferred and other embodiments. The invention is not limited, however, to the embodiments described and depicted herein. Rather, the invention is defined only by the claims appended hereto.

What is claimed is:

1. In a laser system including a regenerative amplifier having a resonator including a gain-medium and an optical switch, a pulsed pump-laser for optically pumping the gain-medium, and a seed pulse laser for providing seed pulses to the regenerative amplifier, the optical switch operable to selectively permit a seed pulse to the circulate within the resonator for amplification and to deliver the amplified seed pulse from the resonator, a method of operating the laser system comprising the steps of:
operating the seed pulse laser to deliver a continuous train of seed pulses at a first pulse repetition frequency;
operating the pump-laser to deliver optical pump pulses to the gain-medium at a second pulse repetition frequency, said second pulse repetition frequency being a fraction 1/N of said first pulse repetition frequency, where N is an integer greater than 1; and
operating the optical switch such that the resonator delivers amplified ones of said seed pulses as a sequence of temporally spaced apart bursts of 2 or more pulses, with the pulse repetition frequency in any of said bursts being 1/M of said second frequency where M is an integer greater than or equal to 1.

2. The method of claim 1, wherein said first frequency is about 100 MHz or less.

3. The method of claim 2, wherein said second frequency is about 0.1 KHz or greater.

4. The method of claim 1, wherein said temporal spacing of said bursts of pulses is two pump-pulse spacings or greater.

5. The method of claim 1, wherein the pulse repetition frequency in each of said bursts is the same.

6. The method of claim 1, wherein the pulse repetition frequency in any one of said bursts is different from the pulse repetition frequency in any other of said bursts.

7. The method of claim 1, wherein the duration each of said bursts is the same.

8. The method of claim 1, wherein the duration of any one of said bursts is different from the duration of any other of said bursts.

9. The method of claim 1, wherein the temporal spacing between each of said bursts is the same.

10. The method of claim 1, wherein the temporal spacing between any one sequential pair of said bursts is different from the temporal spacing between any other sequential pair of said bursts.

11. In a laser system including a regenerative amplifier having a resonator including a gain-medium and an optical switch, a pulsed pump-laser for optically pumping the gain-medium, and a seed pulse laser for providing seed pulses to the regenerative amplifier, said optical switch operable to selectively permit a seed pulse to the circulate within the resonator for amplification and to deliver the amplified seed pulse from the resonator, a method of operating the laser system comprising the steps of:
operating the seed pulse laser to deliver a continuous train of seed pulses at a first pulse repetition frequency;
generating a first electronic signal including a first continuous train of temporally equally-spaced electronic pulses at said first pulse repetition frequency;
dividing the pulse repetition frequency of said first electronic signal to provide a second electronic signal including a second continuous train of temporally equally-spaced electronic pulses at a second pulse repetition frequency, said second pulse repetition frequency being a fraction 1/N of said first pulse repetition frequency, where N is an integer greater than 1;
controlling the pump laser via said second electronic signal such that the pump-laser delivers optical pump pulses to the gain-medium of the regenerative amplifier at the second pulse repetition frequency; and
opening and closing the optical switch in a predetermined temporal relationship with pulses of said second electronic signal such that that the resonator delivers amplified ones of said seed pulses as any one of (i) a continuous train of said amplified seed pulses at a third pulse repetition frequency, said third pulse repetition frequency being a fraction 1/M of said second pulse repetition frequency, where M is an integer greater than 1, and (ii) a sequence temporally spaced apart bursts of 2 or more pulses with the pulse repetition frequency in any of said bursts being 1/M of said second pulse repetition frequency where M is an integer greater than or equal to 1.

12. The method of claim 1, wherein said opening and closing of the optical switch includes opening the optical switch to admit a seed into pulse to the resonator, closing the optical switch to trap the seed pulse in the resonator such that the seed pulse circulates in the resonator through the gain medium and is amplified, and reopening the optical switch to allow said amplified seed pulse to be delivered from the resonator.

13. The method of claim 11, wherein said first frequency is about 100 MHz or less.

14. The method of claim 13, wherein said second frequency is about 0.1 KHz or greater.

15. The method of claim 11, wherein said temporal spacing of said bursts of pulses is two pump-pulse spacings or greater.

16. The method of claim 11, wherein the pulse repetition frequency in each of said bursts is the same.

17. The method of claim 11, wherein the pulse repetition frequency in any one of said bursts is different from the pulse repetition frequency in any other of said bursts.

18. The method of claim 11, wherein the duration each of said bursts is the same.

19. The method of claim 11, wherein the duration of any one of said bursts is different from the duration of any other of said bursts.

20. The method of claim 11, wherein the temporal spacing between each of said bursts is the same.

21. The method of claim 11, wherein the temporal spacing between any one sequential pair of said bursts is different from the temporal spacing between any other sequential pair of said bursts.
